(19) United States
(12) Patent Application Publication
(10) Pub. No.: US 2020/0234512 A1
(43) Pub. Date: Jul. 23, 2020

(54) DYNAMIC DATA COLLECTION FOR VEHICLE TRACKING

(71) Applicant: Complete Innovations Inc., Toronto (CA)

(72) Inventors: Tony Lourakis, Toronto (CA); Alan Fong, Richmond Hill (CA); Jihyun Cho, Toronto (CA)

(21) Appl. No.: 16/249,960

(22) Filed: Jan. 17, 2019

(51) Int. Cl. G07C 5/00; H04Q 9/00; H04L 29/08

(52) U.S. Cl. CPC G07C 5/008; H04Q 9/00; H04Q 2209/823; H04Q 2209/40; H04L 67/12

(57) ABSTRACT

A telematics system comprises a sensor recording a plurality of operating parameters of a vehicle. A data hub coupled to the sensor receives the plurality of operating parameters from the sensor. The data hub comprises a buffer. The data hub transforms the plurality of operating parameters into a plurality of relative operating parameters. Each of the plurality of relative operating parameters comprises a change in one of the plurality of operating parameters since the previous one of the plurality of operating parameters. The data hub stores the plurality of relative operating parameters in the buffer. A wireless modem is coupled to the data hub. The wireless modem transmits the plurality of relative operating parameters to an external server. The data hub performs a fitting of the plurality of relative operating parameters to a shape, discarding any of the plurality of relative operating parameters that are not required.

### FIELD OF THE INVENTION

The present invention relates to the monitoring of motor vehicles and more particularly to the collection and transfer of telematics data from a vehicle to a central system.

### DESCRIPTION OF THE RELATED ART

The tracking and management of vehicles through the use of telematics is an active field. Vehicles host a large number of electronic and mechanical sensors and sensor modules that are interconnected and allow for real-time monitoring of a vehicle and driver. Sensors measure a large number of vehicular parameters including speed, position, acceleration, engine pressure, tire pressure, etc. Sensors may also be used to detect critical events such as slipping, harsh braking, collisions, and others. Sensors are interconnected by any number of standard and proprietary buses such as On-board diagnostics (ODB, CAN, ODB-II) and others.

Vehicles may be equipped with wireless modems that connect the vehicle to wireless networks that may be any of the cellular networks (3G, 4G, LTE, 5G, etc.), WiMAX, WiFi, and others. Vehicles may also be equipped with tags or transponders that are activated when they are in proximity to transponders that may be found at the entrance to facilities, garages, parking lots, toll booths, etc.

Data collected at a central location may be monitored and analyzed in real-time or at a later date.

Traditional data collection for vehicle tracking is based on data being transmitted from the vehicle to the network at fixed intervals. This leads to drawbacks when it is desired to replay and analyze vehicle trips as displayed on management or administrative software. The fixed interval data collection may limit the accurate representation of certain events such as harsh cornering, sudden acceleration, and collisions.

It is desirable to adjusting the interval of collection of data dynamically to give flexibility and higher accuracy in the analysis of vehicle trips and events.

A further drawback is that many sensors also produce data at fixed intervals. This is acceptable in many situations but in cases such as when a vehicle is idling or stopped, unnecessary data is collected and stored. In other cases, the interval is too long and fails to capture high speed or short events such as fast acceleration, cornering, or collisions.

It is desirable for sensor systems to dynamically produce data to allow for more accurate recording of events without losing accuracy while at the same time improving the use of wireless network bandwidth.

### BRIEF SUMMARY

According to a first major aspect of the invention, a telematics system in a vehicle comprises a sensor recording a plurality of operating parameters of the vehicle. A data hub is coupled to the sensor. The data hub receives the plurality of operating parameters from the sensor. The data hub comprises a buffer. The data hub transforms the plurality of operating parameters into a plurality of relative operating parameters. Each of the plurality of relative operating parameters comprises a change in one of the plurality of operating parameters since the previous one of the plurality of operating parameters. The data hub stores the plurality of relative operating parameters in the buffer. A wireless modem is coupled to the data hub. The wireless modem transmits the plurality of relative operating parameters to an external server.

In further embodiments, the data hub performs a fitting of the plurality of relative operating parameters to a shape, discarding any of the plurality of relative operating parameters that are not required to perform the fitting.

In some embodiments the shape is a straight line. In other embodiments, that the shape is a curve.

In further embodiments, the wireless modem transmits the plurality of relative operating parameters to an external server in response to a storage requirement of the plurality of relative operating parameters exceeding a threshold. In other embodiments, the wireless modem transmits the plurality of relative operating parameters to an external server in response a detection of an event.

In further embodiments, in response to the event the data hub receives the plurality of operating parameters at a faster rate than prior to the event.

In other embodiments, the detection of an event occurs while a storage requirement of the plurality of relative operating parameters is below a threshold.

In some embodiments, the plurality of operating parameters comprises a direction and a speed. In other embodiments, the plurality of operating parameters comprises a direction and a displacement. In other embodiments, the plurality of relative operating parameters comprises a x, a y, and a z value.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a vehicular data collection system 100 in accordance with one embodiment.

FIG. 2 illustrates a vehicular portion 200 in accordance with one embodiment.

FIG. 3 illustrates an item 300 in accordance with one embodiment.

FIG. 4 illustrates a data format 400 in accordance with one embodiment.

FIG. 5 illustrates an item 500 in accordance with one embodiment.

### DETAILED DESCRIPTION

The present invention is directed to the monitoring of motor vehicles and more particularly to the collection and transfer of telematics data from a vehicle to a central system.

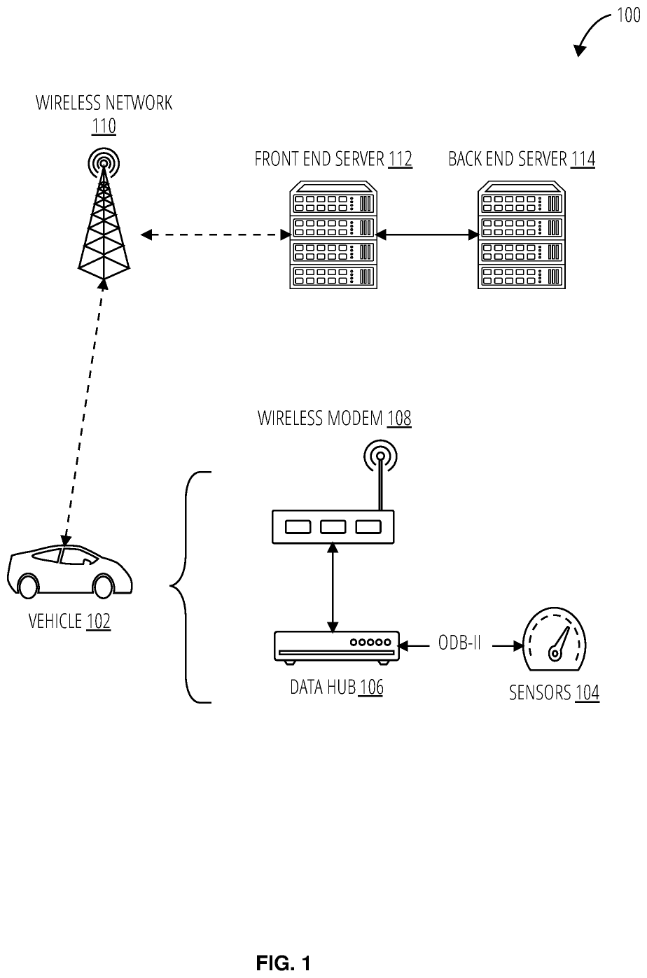

FIG. 1 illustrates a vehicular data collection system 100 where data is collected from vehicles and transmitted to a central server. A vehicle 102 comprises a number of sensors 104 that capture data from any number of onboard devices and modules. Examples of data include vehicular speed, direction of movement and location, tire pressure, facing of vehicle, and rotation, brake pressure and actuation, engine temperature, RPM, interior temperature, number of passengers, and any number of other parameters. The sensors themselves comprise devices such as thermometers, accelerometers, GPS, pressure sensors, etc.

Sensors 104 are connected through one or more vehicular data buses to a data hub 106. An example of a data bus is the ODB-II standard though any other standard or proprietary data bus may be used. The data hub 106 may configure the sensors 104 where applicable and receives data from the sensors 104. Most sensors 104 will transmit data at a fixed period but may also transmit using a variable period using any number of different data formats and protocols. In the case of some sensors 104, the data hub 106 is able to send configuration data to the sensor and to set sensor parameters such as when the sensor transmits data to the data hub 106 or to poll the sensor for new data. Sensors 104 that have local data storage may also be configured through the data hub 106

Data received from the sensors 104 are stored in a buffer or buffers within the data hub 106. The data hub 106 may have the form factor of a standalone box or a dongle, and connects to the ODB port and may also comprise an ODB hub. The data hub 106 will perform data format conversion on the data received from a plurality of sensors 104 that may use different formats. The data hub 106 may also combine or align data received from different sensors at different times to group or combine multiple data sources under the same timestamp. The data hub 106 may also perform the function of configuring and performing updates on any sensors 104 that support such features. Some sensors 104 may also support pre-processing of data that may be used to reduce computation, buffer, or memory requirements of the data hub 106 or the amount of data that is required to be transmitted by the wireless modem 108.

The data hub 106 is coupled to the wireless modem 108 through a vehicle data bus as is well known in the art. The wireless modem 108 supports one or more standard wireless communications protocols including 3G, 4G, 5G, LTE, WiFi (IEEE 802.11), WiMAX, and others. The wireless modem 108 connects to the wireless network 110 to receive information from the server and to transmit sensor information to the server. The wireless modem 108 may connect on demand, when scheduled, or the wireless modem 108 may attempt to make and maintain contact as long and as often as possible. Other methods may also be used.

Data arrives through the wireless network 110 to the server. In some embodiments there is a front end server 112 then a back end server 114. Servers may be virtual, centralized, distributed, cloud, or any other forms as are known in the art.

In most embodiments, the server will collect data from multiple vehicles which allows analysis of data based on a number of factors including over a fleet, vehicle type, characteristics of a driver, location, time, etc.

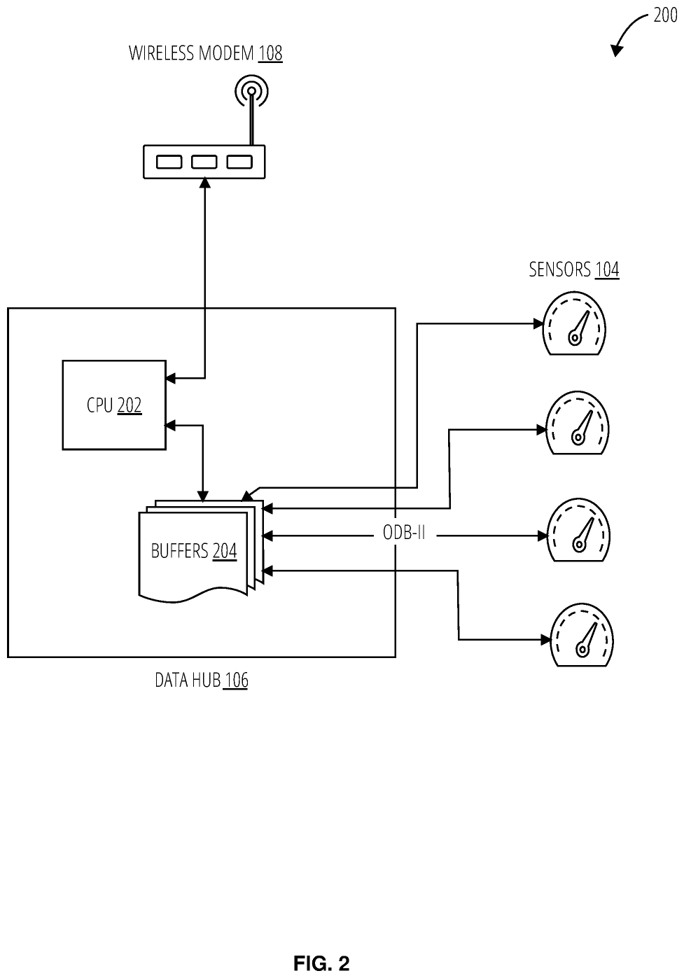

FIG. 2 illustrates vehicular components of a system according to embodiments of the invention. Multiple sensors 104 are connected through a single or multiple ODB-II buses to the data hub 106. The sensors 104 may be polled for data by the data hub 106 or the sensors 104 may send data based on a schedule or based on their own internal buffering or memory capacities.

Data is received by the data hub 106 and stored in buffers 204. The buffers 204 may comprise a single shared buffer, individual buffers for each sensor, or a mix of dedicated and shared buffers. Buffers 204 may be implemented in volatile or non-volatile semiconductor memory or on hard disk.

The data hub 106 comprises semiconductor devices such as a CPU 202, buffers 204 memory, power components, interface components, and may also comprise a user interface such as a display and LEDs to indicate status. Power may come from the 12V DC supply of the vehicle and may also comprise a battery backup or other alternate power supplies. The interface components comprise interfaces to the ODB-II or other bus coupled to the sensors 104 as well as an interface to the wireless modem 108. In some embodiments, the data hub 106 and wireless modem 108 are co-located in the same enclosure or on the same PCB. In other embodiments they are physically separate devices.

The wireless modem 108 may receive power from the vehicle, the data hub 106, a battery, or other source. The wireless modem 108 also comprises the required antennas, amplifiers, receivers, etc. to support its communications protocols.

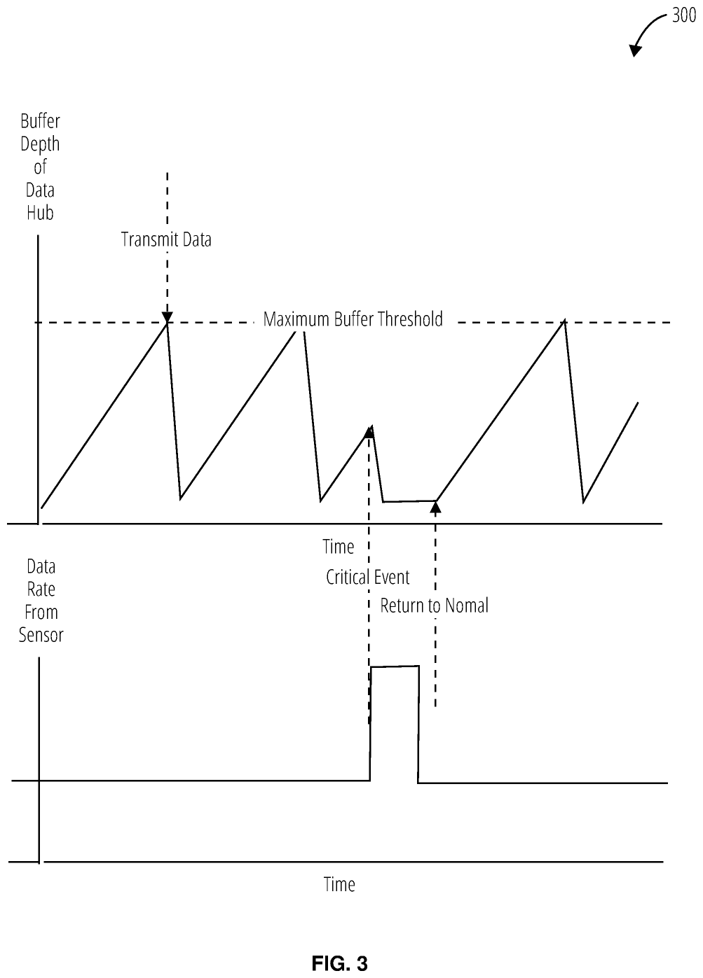

FIG. 3 illustrated the timing and sequence of how data may arrive from the sensors 104 into buffers 204 and then be transmitted to the server. Data may arrive at the buffers 204 in the data hub 106 at a constant or variable rate over a particular period of time and accumulate in the buffers 204. When the amount of data exceeds a maximum buffer threshold, data will be sent through the wireless modem 108, over the wireless network 110, to the front end server 112. Once the data has been transmitted, some or all of the transmitted data is deleted from the data hub 106 buffers 204 to free up space. In other embodiments, after being deleted from the buffers 204, data is logged to another storage device such as a hard disk or solid-state disk. Thresholds may be predetermined or be dynamically calculated based on factors such as sensor data values, wireless network 110 connection status, etc. Transmission may also be initiated by a command from the vehicle operator or from a server. Sensor data then continues to accumulate as the cycle repeats.

When the occurrence of a critical event is detected, data may be transmitted immediately to the front end server 112 without waiting for the amount of data accumulating in the buffers 204 to reach the threshold. Data will typically be transmitted in the order in which it is received, preserving the time sequence. When a critical event occurs, data will be immediately transmitted, and subsequent data may also be immediately transmitted for a predefined time period, at which time, the system returns to normal operation.

Critical events may be events such as collisions, harsh braking, fast acceleration, airbag deployment, temperature out of range, tire pressure, or any other event configured to be of interest to the system, fleet, administrator, vehicle operator, or other stakeholder.

Critical events may be defined by rules that take combinations of sensor data as inputs. Sensor data may be qualified using minimum, maximums, averages, etc. over different periods of time. Sensor data may be combined, weighted, correlated, etc. using techniques as known in the art.

The rate of data generated by a sensor may also vary depending on events in order to capture data at a faster rate or with more accuracy when an event is detected to have occurred. The sensor itself may vary its sampling rate based on what it detects itself, when triggered by another sensor in the vehicle, or when instructed by an external input. For example, when a harsh braking event is detected, other vehicle sensors may be configured to report data at a higher rate than usual.

In some embodiments, during normal operation the data may be transmitted to the front end server 112 once every 2 to 5 minutes. This would include when the vehicle is conducting regular driving, turning, slowing, stopping, and acceleration.

When a critical event happens, this period may be reduced to 1 s or more frequent up to the point of transmitting data as soon as a new sample is available. In the event of a crash data from a period, such as 30 s previous to the crash, may also be transmitted as a group.

In some cases, the vehicle may lose connection to, or be unable to make contact with the wireless network 110. This may occur in remote areas, in situations such as travelling through a tunnel, and other situations. During these situations, data in the buffers 204 may be allowed to temporarily exceed the maximum level, sensors 104 may be configured to reduce the rate at which they generate data, or data may be compressed or merged.

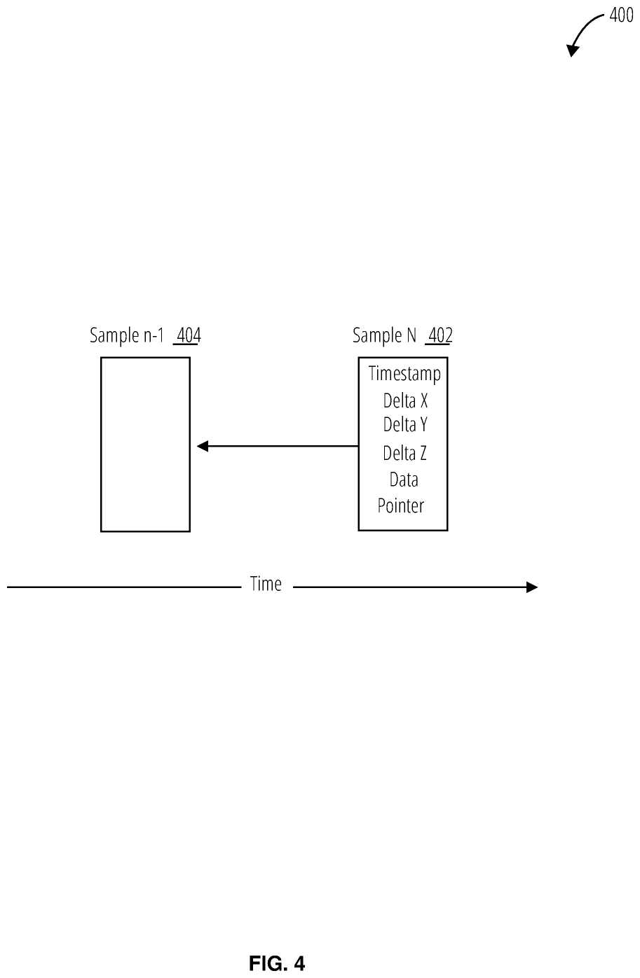

FIG. 4 illustrates an example of data that may be processed by the data hub 106 according to one embodiment of the invention. At each time interval, a data is received from the sensor. In this case of GPS data, this may include an absolute location in longitude or latitude, or as a 3 dimensional x, y, z coordinate. A speed sensor will return a speed in km/hr, m/s, mph, or similar units. An accelerometer will indicate acceleration in similar units.

An absolute location may be used as a starting position and may periodically be used to account for any accumulated errors in relative location data. In some embodiments, an absolute location may be used to reset the location when the speed of the vehicle is below a defined threshold.

For some embodiments, the relative location or displacement since the previous data sample will be used. Sample n 402 comprises a timestamp, a delta x, y, and z value relative to the previous sample n−1 404, a pointer to sample n−1 404, and may also include additional data.

In some cases, samples may be discarded, such as when a vehicle travels in a straight line. In this case samples between when the vehicle started to travel in a straight line and the last sample before it deviates from the straight line may be discarded.

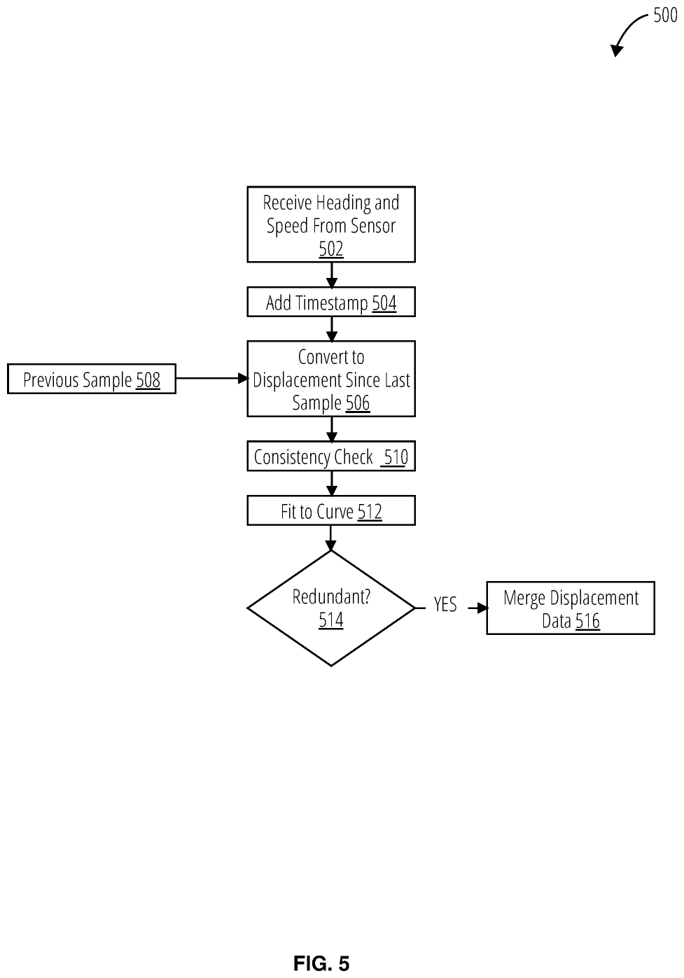

FIG. 5 illustrates a process of reducing the data storage and transmission bandwidth requirements of a system according to an embodiment of the invention. In block 502 data corresponding to a sample n 402, comprising a heading and speed, is received from a sensor or group of sensors in a vehicle. In block 504 timestamp data is added to the data received in block 502. Data from the previous sample n−1 404 is retrieved and used to convert the heading and speed data into displacement data in block 506. In block 510 data is checked for consistency. This may include verifying that the displacement since the last sample n−1 404 is within reasonable thresholds. Thresholds may be set independently for different data types such as GPS position, engine temperature, direction of motion, etc. It may also include verifying the GPS coordinates do not change substantially between sequential points. In some embodiments, data that fails the consistency check is discarded.

To further reduce data storage requirements, displacement data representing a time series of points, may be fit to a curve or other shape in block 512. Other shapes may include quadratic functions and curves, and Bezier curves. In decision block 514, the number of time series displacement data samples may be further reduced by comparing the fitted shape to the data points and removing any redundant data points (block 516) not required to define the shape accurately.

Initial data sets may be used to calculate transmission intervals from the data hub 106 to the front end server 112 to optimize the amount of data and latency of the curve fitting algorithms. The collected data may then become a training data set for building a machine learning model. Once an accurate model is achieved, the model can be used directly to adjust the transmission interval dynamically, based on sensor input. If the data hub 106 is capable, the model can be used to predict the next interval and be compared with real result to self-train using an online training algorithm for real time tuning.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

What is claimed is:

1. A telematics system in a vehicle, the system comprising:
a sensor recording a plurality of operating parameters of the vehicle;
a data hub coupled to the sensor, the data hub receiving the plurality of operating parameters from the sensor, the data hub comprising a buffer, the data hub transforming the plurality of operating parameters into a plurality of relative operating parameters wherein each of the plurality of relative operating parameters comprises a change in one of the plurality of operating parameters since the previous one of the plurality of operating parameters, the data hub storing the plurality of relative operating parameters in the buffer;
a wireless modem coupled to the data hub, the wireless modem transmitting the plurality of relative operating parameters to an external server.

2. The system of claim 1 wherein the data hub performs a fitting of the plurality of relative operating parameters to a shape, discarding any of the plurality of relative operating parameters that are not required to perform the fitting.

3. The system of claim 2 wherein the shape is a straight line.

4. The system of claim 2 wherein the shape is a curve.

5. The system of claim 1 wherein the wireless modem transmits the plurality of relative operating parameters to an external server in response to a storage requirement of the plurality of relative operating parameters exceeding a threshold.

6. The system of claim 1 wherein the wireless modem transmits the plurality of relative operating parameters to an external server in response a detection of an event.

7. The system of claim 6 wherein in response to the event the data hub receives the plurality of operating parameters at a faster rate than prior to the event.

8. The system of claim 6 wherein the detection of an event occurs while a storage requirement of the plurality of relative operating parameters is below a threshold.

9. The system of claim 1 wherein the plurality of operating parameters comprises a direction and a speed.

10. The system of claim 1 wherein the plurality of operating parameters comprises a direction and a displacement.

11. The system of claim 1 wherein the plurality of relative operating parameters comprises a x, a y, and a z value.
